(19) United States
(12) Patent Application Publication
(10) Pub. No.: US 2003/0148031 A1
(43) Pub. Date: Aug. 7, 2003

(54) Accelerating the coloring of concrete and other substrates

(76) Inventors: Thomas W. Urbanek, Calgary (CA); Gregory J. Huber, Calgary (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/068,363

(22) Filed: Feb. 7, 2002

(51) Int. Cl. B05D 3/10; B05D 5/00

(52) U.S. Cl. 427/337

(57) ABSTRACT

A method of treating a substrate that is exposed to the atmosphere, in which the substrate contains an oxidizable metal compound having a color and a development speed under atmospheric conditions, the method comprising the step of contacting the substrate with an oxidizer to increase the development speed of the color. The substrate may be natural, or manmade, such as a hydraulic material, for example concrete. The oxidizer is preferably free of chromates. The oxidizer is preferably applied to the substrate in an aqueous solution.

### CROSS-REFERENCE TO RELATED APPLICATIONS

This application claims the benefit of U.S. provisional application No. ______ filed Jan. 24, 2002.

### BACKGROUND OF THE INVENTION

The coloring of concrete and other substrates with metal compounds, some of which are commonly described as acid stains, is a relatively new industry that is expanding rapidly. The technique provides visually appealing colors to a normally dull surface. Acid stains have a range of colors which depend on the metal compounds used. Under skillful application, the substrate may be made to look like granite, marble or other high quality construction material.

Under prior art, the staining process relies upon natural development of the color under atmospheric conditions, usually in the presence of water. Atmospheric conditions for a reaction means that the reaction takes place exposed to the earth's atmosphere, although it will be appreciated that this atmosphere may be altered slightly by contaminants from local conditions, such as vapors from building or cleaning materials. The process of color development can be very slow, taking hours or even days to complete. Costs are increased since applicators may have to visit application sites several times. Furthermore, the end of the color development, and thereby the final color of the stain, is difficult to predict. Some stains contain chromates (chromium(VI)-compounds), such as sodium dichromate, which somewhat accelerate color development in select colors. Chromates are, however, strongly suspected to be carcinogenic and are only useful in darker colors.

Industry literature generally states that concrete exhibits varying degrees of alkalinity on its surface. It is said that regions of lower alkalinity treated with metal compounds develop color much slower or not at all. The industry currently sells sodium hydroxide and sodium bicarbonate to applicators to improve staining of difficult-to-stain substrates. Even after treating concrete with these alkali, reactions are still generally slow, and it may take hours or days for colors to fully develop.

### SUMMARY OF THE INVENTION

The present invention overcomes these shortfalls, permitting light and dark colors of a stained substrate to be developed within less than 15 minutes. According to an aspect of the invention, an oxidizer is applied to a stained substrate and allowed to react. After the colors are developed, excessive metal compounds and oxidizer may be rinsed off. The decoratively stained substrate may be protected and finished according to conventional practices.

Therefore, according to an aspect of the invention, there is provided a method of treating a substrate that contains an oxidizable metal compound, the method comprising the step of contacting the substrate with an oxidizer to increase the development speed of the color of the oxidizable metal compound. The application of the oxidizer may also be used to develop a specific color. The substrate may be natural, or manmade, such as a hydraulic material, for example concrete. The oxidizer is preferably free of chromates as they are suspected to be carcinogenic. The oxidizer is preferably applied to the substrate in liquid solution, such as in aqueous solution, and may be applied with an acid or base in aqueous solution to ensure oxidative conditions. The oxidizer may for example be selected from the group consisting of peroxides, percarbonates, perborates, peracetates, permanganates, chlorates, perchlorates, peroxymonosulfates, peroxo disulfates, bismuthates, peracids, and organic peroxo compounds, and may be present in solution in an amount from 0.1% to 100% by weight. Any of various construction materials and other substrates may be treated in this manner.

These and other aspects of the invention are described in the detailed description of the invention and claimed in the claims that follow.

### DETAILED DESCRIPTION OF PREFERRED EMBODIMENTS

In this patent document, “comprising” means “including” and does not exclude other elements being present. In addition, a reference to an element by the indefinite article “a” does not exclude the possibility that more than one of the elements is present.

A substrate is any material having a surface that in use is exposed to viewing and that may be stained with a metal compound. Example of substrates are floors, walls, decks, playground surfaces, driveways, sidewalks, roadways, paths, paving stones, tiles, roofing tiles, and architectural features such as countertops, tables, columns, facades and statues. Substrates include man-made materials, for example blocks, bricks, concrete, polymer modified concrete, including overlays, cementitious materials, or other hydraulic materials, and natural materials, for example limestone, marble, and slate. A hydraulic substrate is a substrate made with inorganic compounds that cure by reaction with water.

A metal compound means a chemical compound containing metal cations that are oxidizable and have a desirable color in their higher oxidational state. Examples include metal salts or complexes, mixed metal salts and/or complexes, or mixtures of metal salts and/or complexes. The metal compounds contain cations of metals of the IIIa Group to Va Group, and/or the Ib Group to VIIb Group elements. Preferred oxidizable metal compounds contain cations of titanium, vanadium, chromium, molybdenum, manganese, iron, cobalt, nickel, copper, zinc, cadmium, tin, and bismuth.

Other than with the oxidizers described in the present invention, metal compounds may react with chemical components of the substrate, atmosphere, and simultaneously or sequentially added reagents (other than oxidizers), to form a mixture of reaction products. These chemical components include, but are not limited to, water, oxygen, carbon dioxide, hydroxides, phosphates, and calcium ions. Some metal compounds may, for instance, oxidize naturally under atmospheric conditions and slowly form colored compounds that permanently stain the substrate and give it an aesthetic, natural, or weathered appearance. An example of such a reaction is cited below.

An oxidizer is a substance having a sufficient redox potential to oxidize metal cations or mixtures of metal cations in salts or complexes from a lower oxidational state to a higher oxidational state faster and preferably significantly faster than the naturally occurring process by oxidation with atmospheric oxygen, where the metal cations in the higher oxidational state show a desirable color, and are capable of permanently staining a natural or man-made substrate, and give it an aesthetic, natural, or weathered appearance.

Oxidizers include, but are not limited to, peroxides, percarbonates, perborates, peracetates, permanganates, chlorates, perchlorates, peroxymonosulfates, peroxo fates, bismuthates, derivatives of peroxo acids (peracids), and organic peroxo compounds. Preferred oxidizers include peroxides, percarbonates, perborates, peroxymonosulfates, and peroxo disulfates. Combinations of oxidizers may be used, such as a combination of hydrogen peroxide and sodium percarbonate. A particularly strong oxidizer is sodium peroxide.

As well known to those skilled in the art, the redox potential is generally dependent on the concentration of all reagents participating in the redox reaction, and may, therefore, also be dependent on the pH. For the reactions described in this invention, the pH is determined by the chemical composition of the substrate, the type and concentration of the metal compounds to be oxidized, and the type and concentration of the oxidizers. The pH may have to be altered in consideration of the chemical composition of the substrate (since a substrate may show undesirable reactions at a certain pH), and to permit the oxidation to occur. A suitable pH may be effected by choosing acidic (pH<7), alkaline (pH>7), or neutral (pH=7) oxidizers, sequentially or combined with other chemical components, in general acids or bases, that affect the pH. The methods of determining the pH of a chemical compound or a mixture of chemical compounds, and adjusting the pH are well known to those skilled in the art.

### EXAMPLE 1

Preferred compositions are comprised of an alkaline compound in combination with an oxidizer, in an aqueous solution, for example:

A) 0.1-10% of sodium hydroxide and 0.1-35% of hydrogen peroxide by weight in water; or

B) 0.1-20% of sodium carbonate and 0.1-20% of sodium percarbonate by weight in water; or

C) 0.1-20% of sodium carbonate and 0.1-35% of hydrogen peroxide by weight in water.

### EXAMPLE 2

Preferred compositions are comprised of an alkaline oxidizer, in an aqueous solution, for example:

D) 0.1-10% of sodium peroxide by weight in water; or

E) 0.1-20% of sodium percarbonate by weight in water.

### EXAMPLE 3

Preferred compositions are comprised of a neutral oxidizer in an aqueous solution, for example:

F) 0.1-35% of hydrogen peroxide by weight in water.

### EXAMPLE 4

Preferred compositions are comprised of an acidic compound in combination with an oxidizer, in an aqueous solution, for example:

G) 0.1-10% of hydrogen chloride and 0.1-35% of hydrogen peroxide by weight in water.

### EXAMPLE 5

Preferred compositions are comprised of an acidic oxidizer, in an aqueous solution, for example:

H) 0.1-10% of ammonium persulfate by weight in water.

The application may take place either indoors or outdoors. To treat a substrate, a metal compound is applied to the substrate according to known methods. Oxidative conditions may be assured by selection of a suitable oxidizer, and may require the use of additional acids or bases before, during, or after the application of the metal compound or the oxidizer. After the metal compound is applied to the substrate, the applicator contacts the substrate with an oxidizer to increase the development speed of the color. This is typically accomplished by brushing, rolling, spraying, sponging, squeegeeing, sweeping, sprinkling, or otherwise applying the oxidizer onto the substrate and allowing it to react. Sprinkling may be carried out by sprinkling the oxidizer as a powder onto the substrate and then spraying the powder-covered substrate with an aqueous mist. The oxidizer may be applied undiluted or diluted in a liquid solvent in amounts from 0.1% to 100% by weight. Liquid solvents include water, or organic solvents, such as toluene and xylene, or mixtures of solvents.

Minutes, for example 5 to 15 minutes, after application of the oxidizer, work may be commenced to finish the staining process, for example the substrate may then be rinsed and further protected and finished according to conventional practices. By this method, the development speed of the color may be increased from hours to minutes, resulting in a two-fold, four-fold, ten-fold or greater increase in the development speed.

As a specific example, a concrete substrate is treated with a solution of manganese(II)chloride and iron(II)chloride in water, according to known methods. At the pH of concrete, and even after raising the pH with a base such as sodium hydroxide, development of the brown color, originating from the formation of manganese(IV) and iron(III) cations, is very slow and may take hours to occur. After the application of an oxidizer, such as 4% hydrogen peroxide (by weight) and 1% sodium hydroxide (by weight) in water, color development is completed within less than 5 minutes compared with more than 24 hours in conventional conditions. Safety considerations may dictate an upper limit on the concentration of the oxidizer, for example 35% or 50% by weight for hydrogen peroxide in aqueous solution.

Typical reactions that occur are:

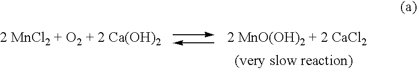

Equation (a) shows a reaction of a metal compound under alkaline (concrete) and atmospheric conditions. The reaction remains slow even if the pH is raised with alkali.

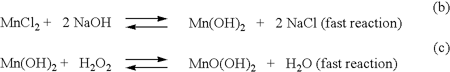

Equations (b) and (c) show a reaction of a metal compound under alkaline conditions, and the subsequent oxidation of the reaction product with an oxidizer.

2FeCl₂+H₂O₂+2Ca(OH)₂ [symbol] 2FeO(OH)+2H₂O+2CaCl₂(fast reaction)

Equation (d) shows a reaction of a metal compound under alkaline conditions in presence of an oxidizer.

Immaterial modifications may be made to the invention described here without departing from the essence of the invention.

We claim:

1. A method of treating a substrate, in which the substrate contains an oxidizable metal compound having a color and a development speed under atmospheric conditions, the method comprising the step of:
contacting the substrate with an oxidizer to increase the development speed of the color.

2. The method of claim 1 further comprising the step of contacting the substrate with a base.

3. The method of claim 1 in which the substrate is contacted with the oxidizer in solution.

4. The method of claim 3 in which the oxidizer is selected from the group consisting of peroxides, percarbonates, perborates, peracetates, permanganates, chlorates, perchlorates, peroxymonosulfates, peroxo disulfates, bismuthates, and peracids.

5. The method of claim 4 in which the oxidizer is selected from the group consisting of sodium percarbonate, sodium peroxide, and hydrogen peroxide.

6. The method of claim 1 in which the substrate is contacted with the oxidizer in aqueous solution.

7. The method of claim 6 in which the oxidizer is present in the aqueous solution in an amount at least 0.1% by weight.

8. The method of claim 7 in which the oxidizer is hydrogen peroxide.

9. The method of claim 7 in which the oxidizer is sodium percarbonate.

10. The method of claim 7 in which the oxidizer is sodium peroxide.

11. A method of treating a substrate, in which the substrate contains an oxidizable metal compound having a color and a development speed under atmospheric conditions, the method comprising the step of:
contacting the substrate with an oxidizer free of chromates to increase the development speed of the color.

12. The method of claim 11 further comprising the step of contacting the substrate with a base.

13. The method of claim 11 in which the substrate is contacted with the oxidizer in solution.

14. The method of claim 13 in which the oxidizer is selected from the group consisting of peroxides, percarbonates, perborates, peracetates, permanganates, chlorates, perchlorates, peroxymonosulfates, peroxo disulfates, bismuthates, and peracids.

15. The method of claim 14 in which the oxidizer is selected from the group consisting of sodium percarbonate, sodium peroxide, and hydrogen peroxide.

16. The method of claim 11 in which the substrate is contacted with the oxidizer in aqueous solution.

17. The method of claim 16 in which the oxidizer is present in the aqueous solution in an amount at least 0.1% by weight.

18. The method of claim 17 in which the oxidizer is hydrogen peroxide.

19. The method of claim 17 in which the oxidizer is sodium percarbonate.

20. The method of claim 17 in which the oxidizer is sodium peroxide.

21. A method of coloring a substrate, the method comprising the steps of:
applying an oxidizable metal compound to the substrate; and, subsequently,
contacting the substrate with a solution containing an oxidizer to oxidize the oxidizable metal compound.

22. The method of claim 21 in which the substrate is manmade.

23. The method of claim 22 in which the substrate is a hydraulic material.

24. The method of claim 21 in which the substrate is concrete .

25. The method of claim 21 in which the solution is an aqueous solution.

26. The method of claim 25 in which the aqueous solution has a pH greater than 7.0.

27. The method of claim 26 in which the oxidizer is hydrogen peroxide in an aqueous solution containing sodium carbonate.

28. The method of claim 21 in which the oxidizer is contacted with the substrate by sprinkling the oxidizer in powder form onto the substrate and spraying the powdered substrate with an aqueous mist.

29. A method of coloring concrete, the method comprising the steps of:
staining concrete with a metal compound having a color; and
enhancing development speed of the color of the metal compound by contacting the concrete with an oxidizer in liquid solution.

30. The method of claim 29 in which the oxidizer is selected from the group consisting of peroxides and percarbonates.

31. The method of claim 30 in which the oxidizer is present in an amount exceeding 0.1% by weight of the liquid solution.

32. The method of claim 31 in which the liquid solution is an aqueous solution.

33. The method of claim 32 in which the aqueous solution has a pH greater than 7.0.

34. The method of claim 29 in which the liquid solution contains an organic solvent.

35. The method of claim 29 in which the concrete is stained with an acid solution containing a metal salt.

36. The method of claim 35 in which the metal salt is a salt of a metal selected from the group consisting of iron, chromium, copper, and manganese.

37. A method of coloring construction material, the method comprising the steps of:
staining the construction material with a metal compound having a color; and
enhancing development speed of the color of the metal compound by contacting the construction material with an oxidizer in aqueous solution.

38. The method of claim 37 in which the construction material is in the form of a feature selected from the group consisting of floors, walls, decks, playground surfaces, driveways, sidewalks, roadways, paths, paving stones, tiles, roofing tiles, countertops, tables, columns, facades and statues.

39. A method of coloring a substrate, the method comprising the steps of:
applying an oxidizable metal compound to the substrate; and
subsequently, contacting the substrate with an aqueous solution containing an oxidizer to oxidize the oxidizable metal compound,
wherein the oxidizer is selected from the group consisting of peroxides and percarbonates and the oxidizer is present in an amount exceeding 0.1% by weight of the aqueous solution.

40. A method of treating a manmade substrate, in which the manmade substrate contains an oxidizable metal compound having a color and a development speed under atmospheric conditions, the method comprising the step of:
contacting the manmade substrate with an oxidizer to increase the development speed of the color.

41. A method of treating a hydraulic substrate that is exposed to the atmosphere, in which the hydraulic substrate contains an oxidizable metal compound having a color and a development speed under atmospheric conditions, the method comprising the step of:
contacting the hydraulic substrate with an oxidizer to increase the development speed of the color.

42. A method of treating concrete, in which the concrete contains an oxidizable metal compound having a color and a development speed under atmospheric conditions, the method comprising the step of:
contacting the concrete with an oxidizer free of chromates to increase the development speed of the color.
